(19) United States
(12) Patent Application Publication
(10) Pub. No.: US 2026/0057624 A1
(43) Pub. Date: Feb. 26, 2026

(54) VIRTUAL NOSE LINE SHAPING DEVICE AND METHOD THEREOF

(71) Applicant: BISTOOL INC., Seoul (KR)

(72) Inventor: Eun Hyun BAE, Seoul (KR)

(21) Appl. No.: 19/291,417

(22) Filed: Aug. 5, 2025

(30) Foreign Application Priority Data
Aug. 21, 2024 (KR) 10-2024-0111699
Oct. 28, 2024 (KR) 10-2024-0148199
Jan. 22, 2025 (KR) 10-2025-0009591

(51) Int. Cl. G06T 19/20

(52) U.S. Cl. CPC G06T 19/20; G06T 2219/2004; G06T 2219/2021

(57) ABSTRACT

Proposed is a virtual nose line shaping device and a method thereof. The virtual nose line shaping device includes a face data input unit for inputting facial data generated by capturing or scanning a patient's face, a nose line DB for storing nose line data for at least one nose line, a virtual nose shaping unit for displaying the nose line selected by the patient, generating a plurality of reference points for virtual nose shaping by analyzing the patient's facial data, and performing the virtual nose shaping with reference to the nose line data included in the nose line selected by the patient when moving the reference point in accordance with the nose line selected by the patient, and a display unit for displaying a process and outcome of the virtual nose shaping.

### CROSS REFERENCE TO RELATED APPLICATION

The present application claims priority to Korean Patent Application Nos. 10-2024-0111699, 10-2024-0148199 and 10-2025-0009591, filed on Aug. 21, 2024, Oct. 28, 2024, and Jan. 22, 2025, respectively, the entire contents of which are incorporated herein for all purposes by this reference.

### BACKGROUND

### Technical Field

The present disclosure relates to a virtual nose line shaping device and a method thereof and, more specifically, to a virtual nose line shaping device and a method thereof for performing virtual nose shaping by generating a plurality of reference points for the virtual nose shaping on the basis of an analysis of a patient's facial data and by moving the reference points in accordance with a nose line selected by the patient.

### Description of the Related Art

In recent years, the global trend in the plastic surgery field is shifting toward the use of virtual plastic surgery that allows patients to preview postoperative outcomes in advance.

However, the current virtual nose shaping not only has to be performed through complex software after scanning with expensive equipment, but also there are not many hospitals with that expensive equipment and software, and a virtual shaping application easily accessible cannot apply the results to actual surgery, so medical equipment and methods are needed to solve these practical and cost problems and offer more substantial assistance to patients and doctors.

### SUMMARY

An objective of the present disclosure is to provide a device and method capable of easily performing virtual nose line shaping by using a patient's facial data captured by a mobile device, of setting reference points and reference angles based on the patient's side facial contour required for delicate modification of a nose line, and of performing the virtual nose line shaping in accordance with the set references.

The present disclosure provides a virtual nose line shaping device, which includes a face data input unit for inputting facial data generated by capturing or scanning a patient's face, a nose line DB for storing nose line data for at least one nose line, a virtual nose shaping unit for displaying the nose line selected by the patient, generating a plurality of reference points for virtual nose shaping by analyzing the patient's facial data, and performing the virtual nose shaping with reference to the nose line data included in the nose line selected by the patient when moving the reference point in accordance with the nose line selected by the patient, and a display unit for displaying a process and outcome of the virtual nose shaping.

Herein, the facial data may be generated by using a mobile device, and the virtual nose line shaping device may be the mobile device or a personal computer (PC).

Herein, the nose line may include a straight line, a straight but slightly turned-up line, a slightly turned-up line, and a turned-up line, and the nose line data may include information for forming the nose line.

Herein, the virtual nose shaping unit may include a nasal dorsum curvature change setting module for measuring the patient's nasal dorsum curvature and setting an amount of change in the patient's nasal dorsum curvature by reflecting the nose line selected by the patient on the basis of the measurement, a reference point setting module for setting the plurality of reference points along a contour of the patient's side facial line for the nose shaping, a reference angle setting module for setting at least one reference angle related to the nose from the patient's side facial line by analyzing the facial data, and a virtual nose shaping control module for controlling to perform the virtual nose shaping within a range not deviating from the reference angle set appropriately for the patient when performing the virtual nose shaping in which the amount of change in the nasal dorsum curvature set by using the reference points is reflected.

Herein, the plurality of reference points may include a glabella, nasal dorsum, rhinion, supratip, nasal tip, columnella, subnasale, and pogonion.

Herein, the reference angle may be set to each angular range for a nasofrontal angle, nasal angle, nasolabial angle, facial convexity, and total facial convexity, appropriate for the corresponding patient, on the basis of an analysis of the patient's facial data when performing the virtual nose shaping by applying the nose line selected by the patient.

Herein, the nose shaping control module may perform the virtual nose shaping by automatically moving positions of remaining reference points when moving at least one reference point in accordance with the nose line selected by the patient, wherein a movement range of the reference point is controlled to be movable within a range not deviating from the set reference angle.

Herein, when a nose length, proportion, and reference angle change according to a movement of the reference point during the virtual shaping, the amount of change may be visualized and displayed, and an extent of the visualization is displayed in proportion to the amount of change.

Herein, there is further included a nose shaping guide information providing unit for providing guide information in performing rhinoplasty by predicting changes in the patient's internal nasal structure and the corresponding functional changes when performing the actual rhinoplasty by receiving and analyzing the patient's facial CT data, combining and displaying the process and outcome of the virtual nose shaping with the facial CT data, and applying the nose line selected by the patient.

In addition, the present disclosure provides a virtual nose line shaping method, which includes a) inputting, by a face data input unit, facial data generated by capturing or scanning a patient's face, b) displaying, by a virtual nose shaping unit, the patient's facial data and displaying the corresponding nose line when the patient selects a nose line, c) displaying, by the virtual nose shaping unit, a plurality of reference points for virtual nose shaping on the patient's face by analyzing the patient's facial data, d) performing, by the virtual nose shaping unit, the virtual nose shaping with reference to a nose line data included in the nose line selected by the patient when moving the reference point in accordance with the nose line selected by the patient and e) displaying, by a display unit, a process and outcome of the virtual shaping reflecting the nose line.

Herein, the facial data may be generated by using a mobile device.

Herein, the nose line may include a straight line, a straight but slightly turned-up line, a slightly turned-up line, and a turned-up line, each of which comprises the nose line data for forming the corresponding nose line.

Herein, step d) may include d-1) setting, by a nasal dorsum curvature change setting module, an amount of change in the patient's nasal dorsum curvature by reflecting the nose line selected by the patient onto the patient's side face on the basis of the patient's nasal dorsum curvature by analyzing the facial data, d-2) setting, by a reference angle setting module, at least one reference angle related to the nose on the patient's side facial line by analyzing the facial data and reflecting the nose line selected by the patient onto the patient's face, d-3) moving, by a virtual nose shaping control module, at least one reference point among the reference points formed on the patient's side facial line with reference to the amount of change in the patient's set nasal dorsum curvature, and d-4) performing, by the virtual nose shaping control module, the virtual nose shaping by automatically moving positions of remaining reference points when moving at least one reference point in accordance with the nose line selected by the patient, wherein a movement range of the reference point is controlled to be movable within a range not deviating from the set reference angle.

Herein, the plurality of reference points may include a glabella, nasal dorsum, rhinion, supratip, nasal tip, columnella, subnasale, and pogonion.

Herein, the reference angle may be each angular range for a nasofrontal angle, nasal angle, nasolabial angle, facial convexity, and total facial convexity, appropriate for the corresponding patient, on the basis of an analysis of the facial data in order to perform the virtual shaping with the selected nose line.

Herein, step e) may visualize and display the amount of change when the reference point and the reference angle change during the virtual shaping, wherein an extent of the visualization is displayed in proportion to the amount of change.

Herein, the method further includes f) receiving and analyzing the patient's facial CT data by a nose shaping guide information providing unit, g) combining and displaying the process and outcome of the virtual nose shaping with the facial CT data by the nose shaping guide information providing unit, and h) generating and providing, by the nose shaping guide information providing unit, guide information on a surgical area to be operated, and shaping outcome information on predicting changes in the patient's internal nasal structure and the corresponding functional changes when performing an actual rhinoplasty with the nose line selected by the patient by applying the outcome of the virtual shaping, to which the nose line selected by the patient is applied, to the facial CT data.

The present disclosure may have the effect of allowing the selected nose line to be easily applied to a patient's face by setting reference points for a virtual nose line on the patient's facial data and moving the reference points.

The present disclosure may have the effect of enabling more natural and detailed nose line shaping during the virtual nose line shaping by additionally setting a reference point and a reference angle for forming a natural facial contour and by restricting the reference point to move with reference to the reference angle.

The present disclosure may have the effect of significantly reducing the initial setup cost required to establish 3D scanner equipment, which is the biggest obstacle to generalizing the virtual shaping in the current plastic surgery industry, by capturing and scanning a patient's face using a mobile device.

### BRIEF DESCRIPTION OF THE DRAWINGS

FIG. 1 is a view illustrating a virtual nose line shaping device according to an exemplary embodiment of the present disclosure.

FIG. 2 is a configuration diagram of a virtual nose line shaping device according to an exemplary embodiment of the present disclosure.

FIG. 3 is a view illustrating a type of a nose line according to an exemplary embodiment of the present disclosure.

FIG. 4 is a view illustrating a reference straight line for measuring a nasal dorsum curvature and an extent deviating from the reference straight line according to an exemplary embodiment of the present disclosure.

FIG. 5 is a configuration diagram of a virtual nose shaping unit according to an exemplary embodiment of the present disclosure.

FIG. 6 is a view illustrating that a plurality of reference points are set on a patient's side face according to an exemplary embodiment of the present disclosure.

FIG. 7 is a view illustrating a type of a reference angle according to an exemplary embodiment of the present disclosure.

FIG. 8 is a view illustrating a virtual nose line shaping method according to an exemplary embodiment of the present disclosure.

FIG. 9 is a view illustrating a nose line shaping control method of a virtual nose shaping unit according to an exemplary embodiment of the present disclosure.

FIG. 10 is a view illustrating a method of generating and providing guide information for plastic surgery by referring to a patient's facial CT data according to an exemplary embodiment of the present disclosure.

### DETAILED DESCRIPTION OF THE DISCLOSURE

Hereinafter, preferred exemplary embodiments of the present disclosure will be described with reference to the accompanying drawings.

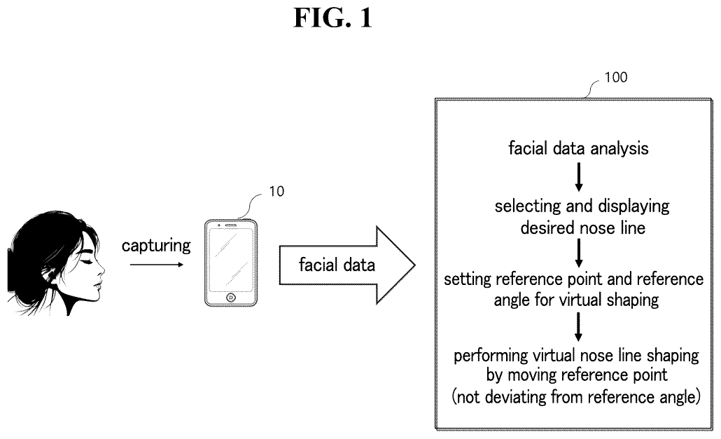

FIG. 1 is a view illustrating a virtual nose line shaping device according to an exemplary embodiment of the present disclosure.

The virtual nose line shaping device 100 of the present disclosure may be a device that receives and analyzes facial data obtained by capturing or scanning a patient's face and performs virtual nose shaping with a nose line selected by the patient, and may include, for example, a mobile device such as a smartphone capable of driving a program for the virtual nose line shaping or a device including a computer such as a personal computer (PC).

During the virtual shaping, the patient's side face may be displayed, a plurality of reference points for the virtual shaping may be set on the side facial line, and a reference point for the virtual shaping may be selected among the set reference points and moved in accordance with the selected nose line, thereby performing virtual shaping with the desired nose line.

The patient's facial data for the virtual shaping may be generated by capturing the patient's face using a camera or a LiDAR sensor of a mobile device 10, such as a smartphone.

Herein, when capturing the patient's face using a camera instead of a LiDAR sensor, five parts of the face, such as the front of the face, both sides of the face on 45-degree angles, and both sides of the face, may be captured to generate more accurate facial data of the patient.

Thereafter, the virtual nose line shaping device 100 may receive the patient's facial data from the mobile device 10.

The virtual nose line shaping device 100 may analyze the patient's input facial data and generate and display a line shape of the patient's face for the virtual shaping.

Herein, the line shape of the patient's face may be a front and side line, but may be mainly displayed in a line of the side face.

The virtual nose line shaping device 100 may display the patient's side facial line and can display the corresponding nose line together with the patient's side facial line when the patient selects a desired nose line.

In addition, the virtual nose line shaping device 100 may set a reference point and a reference angle for the virtual shaping, wherein the reference point is displayed on the patient's side facial line.

Thereafter, the person performing the virtual nose line shaping may perform the virtual nose shaping by moving the reference points, which are set through the virtual nose line shaping device 100 and displayed on the display unit, in accordance with the nose line selected by the patient.

Herein, when some reference points move, the virtual nose line shaping device 100 may automatically move the remaining reference points within a range not deviating from the reference angle set appropriately for the selected nose line such that the selected nose line is controlled to be naturally aligned with the patient's face, thereby displaying a natural appearance of the patient's face with the selected nose line applied.

Herein, the reference angle may refer to an angular range in which the selected nose line can be ideally aligned with the contour of the patient's facial line when the selected nose line is applied to the patient's face, and the virtual nose line shaping device 100 may control the virtual nose shaping to be performed within a range not deviating from the reference angle set appropriately for the patient when performing the virtual nose shaping by moving the reference point.

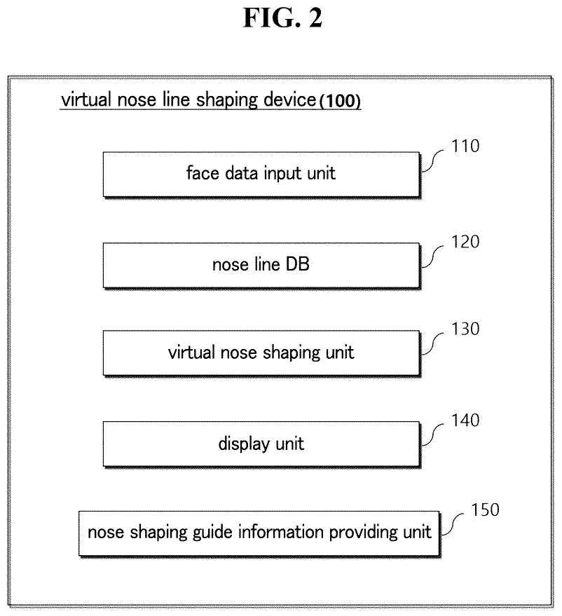

FIG. 2 is a configuration diagram of a virtual nose line shaping device according to an exemplary embodiment of the present disclosure.

The virtual nose line shaping device 100 of the present disclosure may include a face data input unit 110, a nose line DB 120, a virtual nose shaping unit 130, a display unit 140, and a nose shaping guide information providing unit 150.

The face data input unit 110 may be a component to which the facial data generated by capturing or scanning the patient's face is input.

The nose line DB 120 may be a component for storing nose line data for one or more nose lines.

The nose line DB 120 may store information on the nose line and data on the nose line for forming the nose line.

Herein, the nose line may be generally classified into a straight line, a straight but slightly turned-up line, a slightly turned-up line, and a turned-up line, and can be further classified in more detail depending on the requirements of the virtual nose shaping.

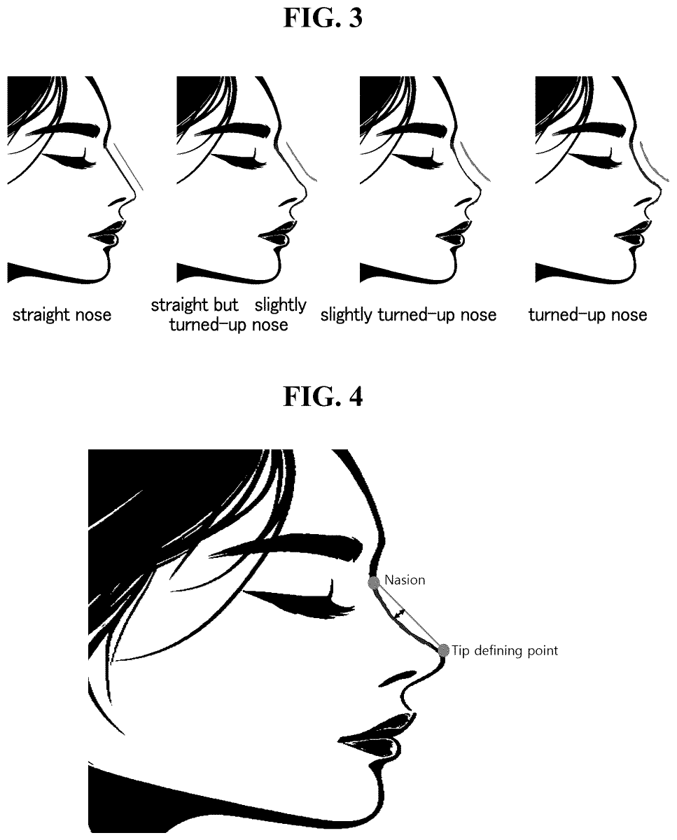

FIG. 3 is a view illustrating a type of a nose line according to an exemplary embodiment of the present disclosure.

The criteria for classifying nose lines may be based on visual curves, but the nose lines can be numerically classified by the nasal dorsum curvature.

When measuring the nasal dorsum curvature, a “straight line” usually used as a reference may be the straight line connecting the nasion, which runs across the nasal dorsum, to the nasal tip, and the nasal dorsum curvature may refer to the extent of deviating from the straight line connecting these two points, indicating the extent of concaveness in the nasal dorsum line.

FIG. 4 is a view illustrating a reference straight line for measuring a nasal dorsum curvature and an extent deviating from the reference straight line according to an exemplary embodiment of the present disclosure.

That is, as illustrated in FIG. 4, the nasal dorsum curvature may be represented by measuring and quantifying how far the nasal dorsum line deviates from the reference straight line, and on the basis of this quantification, the following four types of nose lines can be classified.

The nasal dorsum curvature may be represented in millimeters, indicating how far the nasal dorsum line drops below the reference straight line.

The following are the four types of the nose lines and information (points of consideration) for forming the corresponding nose lines.

1. A straight nose line may be a shape in which a line from the nasal dorsum to the nasal tip is almost a straight line with no curves or bends, giving the impression that the nasal dorsum and the nasal tip are on the same line.

The nasal dorsum curvature of the straight nose line is almost 0 in a straight line.

2. A straight but slightly turned-up nose line may be a shape, in which the nasal tip is very slightly raised up, with a slight upturn of the tip but no significant curve.

The nasal dorsum curvature of the straight but slightly turned-up nose line may be a curvature of about 1 mm.

3. A slightly turned-up nose line may exhibit a noticeable curvature as extending from the nasal dorsum toward the nasal tip, and may be a nose shape less upturned than a turned-up nose.

The nasal dorsum curvature of the slightly turned-up nose line may be a curvature of about 2-3 mm.

4. The turned-up nose line may be a nose shape in which the curve of the nasal dorsum is most pronounced, and the nasal tip is raised upward like the shape of a traditional Korean “beoseon” (a curved sock).

The nasal dorsum curvature of the turned-up nose line may be about 4 mm or more, and in some cases, may reach 5 to 6 mm.

The nose line DB 120 may include the aforementioned types of nose lines and data on the nasal dorsum curvature for forming the corresponding nose line.

The virtual nose shaping unit 130 may be a component for displaying a nose line selected by the patient, generating a plurality of reference points for the virtual nose shaping by analyzing the patient's facial data, and then performing the virtual nose shaping with reference to the nose line data included in the nose line selected by the patient when moving the reference points in accordance with the nose line selected by the patient.

The display unit 140 may be a component for displaying a process and outcome of the virtual nose shaping.

When the patient's facial CT data is input, the nose shaping guide information providing unit 150 may receive and analyze the patient's facial CT data and may display the process and outcome of the virtual nose shaping in combination with the facial CT data.

In addition, the nose shaping guide information providing unit 150 may generate and provide guide information in performing the rhinoplasty by predicting changes in the patient's internal nasal structure and corresponding functional changes using the results of analyzing facial CT data when performing an actual rhinoplasty by applying the nose line selected by the patient.

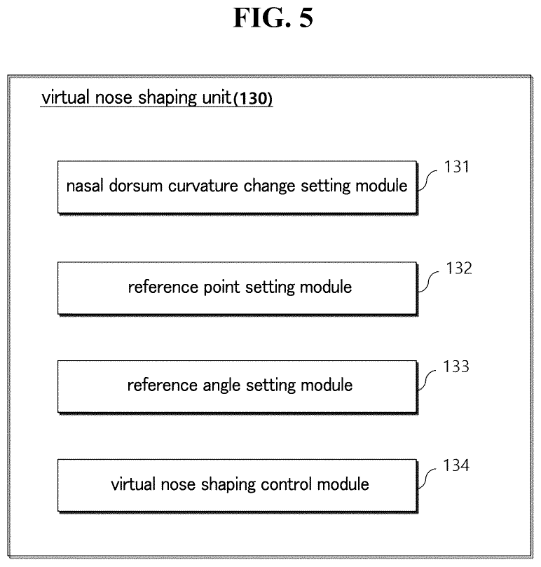

FIG. 5 is a configuration diagram of a virtual nose shaping unit according to an exemplary embodiment of the present disclosure.

The virtual nose shaping unit 130 of the present disclosure may include a nasal dorsum curvature change setting module 131, a reference point setting module 132, a reference angle setting module 133, and a virtual nose shaping control module 134.

The nasal dorsum curvature change setting module 131 may measure the patient's nasal dorsum curvature, and, on the basis of this, may reflect the nose line selected by the patient, thereby setting the amount of change in the patient's nasal dorsum curvature during the virtual shaping.

In addition, the nasal dorsum curvature change setting module 131 may display the nose line selected by the patient on the patient's side face and display the amount of change in the patient's set nasal dorsum curvature, such that the patient can visually know the extent of change in the nose line in the rhinoplasty.

The reference point setting module 132 may perform a function of setting a plurality of reference points for the nose shaping along the contour of the patient's side facial line.

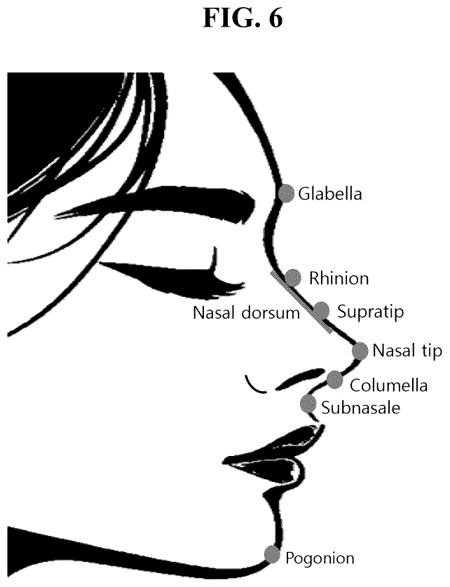

FIG. 6 is a view illustrating that a plurality of reference points are set on a patient's side face according to an exemplary embodiment of the present disclosure.

The plurality of reference points set by the reference point setting module 132 may include a glabella, rhinion, supratip, nasal tip, columnella, subnasale and pogonion.

In addition, the nasal dorsum and the alar-columella relationship (ACR), which are not points but represent lengths, may be included.

The following may describe the meaning of each reference point and key considerations for the virtual shaping.

1. Glabella is a reference point that influences the total facial convexity and facial convexity, such that the height should be adjusted while checking the overall proportions, paying attention to the connection with the subnasale during the shaping.

2. Nasal dorsum is an important reference line that determines the nasal dorsum curvature and, when the nasal dorsum is too concave or convex depending on the nasal dorsum curvature, the outcome may appear unnatural, so careful attention should be paid when adjusting the smoothness or straightness of the nose line during the shaping.

The nasal dorsum may be an important point for distinguishing between the straight nose and the turned-up nose, wherein the straight nose exhibits almost no curve, and the turned-up nose is highlighted by the curve.

3. Rhinion is the boundary point between the nasal bone and the upper lateral cartilage, the highest point in the nasal dorsum and an important reference point of the nose contour.

An excessively low or high position of the rhinion can result in an unnatural nasal dorsum, such that the length and height of the nose and the proportional harmony with the nasal tip should be considered during the shaping, and careful attention should be paid to ensure that the line connecting the nasal dorsum and the nasal tip is naturally connected so that there is no sense of disconnection or imbalance in the middle.

4. Supratip is a region forming a soft curve slightly sunken between the nasal dorsum and the nasal tip and is an important reference point for determining the natural and sophisticated nose shape.

Modifying the height of the supratip may directly influence the nose's side line during the shaping, thereby changing the extent of the curve, the smoothness, and the proportional harmony, so an excessive height difference from the nasal tip can result in an appearance disproportionate to the face.

5. Nasal tip is an important reference point that determines the overall impression of the nose. An excessively blunt or sharp nasal tip may disrupt facial balance, so it should be appropriately adjusted during the shaping, and the shape of the nose line should be set in consideration of the nasal projection and the nasal tip rotation together. An excessively upturned or drooping nasal tip can result in disharmonious proportions.

In general, a more straight and strong nasal tip may be preferred for men, and a softer and slightly upturned nasal tip may be often preferred in women.

6. Columella refers to an area blocking between the nostrils.

The columella should be adjusted to be appropriately visible during the shaping and may affect the rotation of the nasal tip and the shape of the nostril. When it is overly exposed, the outcome may appear artificial, while the nasal tip looks droopy when it is too little visible.

7. Subnasale is an important reference point when adjusting the nasolabial angle, which is the angle between the nose and the upper lip.

For a natural appearance, this angle should be set between 90° to 95° in men and 95° to 110° in women. When the nasal tip is raised too much during the shaping, the nasolabial angle may become excessively large at this point and look unnatural.

8. Pogonion is a point on the tip of the chin, and may play an important role in harmonizing the overall facial proportions and profile.

The position and projection of the chin tip should be adjusted during the shaping, such that the balance of the overall profile is maintained after the nose shaping, and careful attention should be paid in order to avoid situations in which the chin appears relatively prominent or recessed after the nose shaping.

In addition, it may be utilized together with the glabella in order to measure total facial convexity and facial convexity.

Herein, the alar-columella relationship (ACR), which does not represent a point but is an important criterion for the nose shaping, may be further included.

The ACR may describe the proportion, angle, and positional relationship between the alar base and the columella, and may serve as an important reference for evaluating the overall shape of the nose, particularly the harmony around the nostrils and the nasal tip.

A more harmonious plastic surgery outcome can be derived during the shaping by improving the proportion of the nose relative to the entire face and by also adjusting the nasal tip projection and the nasal tip rotation through the optimization of how much the columella is exposed (columella show) on the basis of the angle (alar-columella angle) between the edge of the nostril and the columella, and the side.

The reference point setting module 132 may analyze the patient's facial data and may set the positions of the aforementioned reference points.

The reference angle setting module 133 may analyze the patient's facial data and may perform a function of setting at least one reference angle related to the nose in the patient's side facial line.

Herein, the reference angle may be the angle forming the facial contour line related to the corresponding nose, including a nasofrontal angle, a nasal angle, a nasolabial angle, a facial convexity, and a total facial convexity.

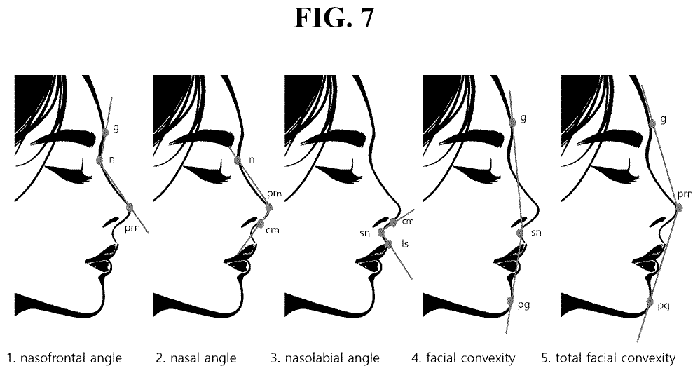

FIG. 7 is a view illustrating a type of a reference angle according to an exemplary embodiment of the present disclosure.

The nasofrontal angle may refer to the angle formed by the line connecting the glabella (g), nasion (n), and pronasale (pr), and the ideal angle may be between 120° and 130° for women, and between 115° and 125° for men.

The nasal angle may refer to the angle formed by the line connecting the nasion (n), pronasale (prn), and columnella (cm), and the ideal angle may be between 95° and 105° for women and between 90° and 95° for men.

The nasolabial angle may refer to the angle formed by the line connecting the columnella (cm), subnasale (sn) and labiale superius (Is), and the ideal angle may be between 95° and 105° for women and between 90° and 95° for men.

The facial convexity may refer to the angle formed by the line connecting the glabella (g), subnasale (sn) and pogonion (pg), ranging from 165° to 175°, and the ideal angle may be between 170° and 175° for women, and be a slightly smaller angle closer to 165° for men.

The total facial convexity may refer to the angle formed by the line connecting the glabella (g), pronasale (pr), and pogonion (pg), ranging from 125° to 135°, and ideal angle may be between 130° and 135° for women, and be a slightly smaller angle closer to 125° for men.

When performing the virtual nose shaping by applying the nose line selected by the patient, the reference angle setting module 133 may analyze the patient's facial data and may set each angular range for the nasofrontal angle, nasal angle, nasolabial angle, facial convexity, and total facial convexity appropriate for the corresponding patient.

For example, when the patient is a woman, an angular range appropriate for the patient may be set within each angular range for a woman and, when the patient is a man, an angular range appropriate for the patient may be set within each angular range for a man.

The virtual nose shaping control module 134 may perform a function of controlling the virtual nose shaping to be performed within a range not deviating from the reference angle set appropriately for the patient when the virtual nose shaping reflects the amount of change in the patient's nasal dorsum curvature set using the reference point.

The virtual nose shaping control module 134 may control the remaining reference points to move affecting each other in order not to deviate from the set reference angle when performing the virtual nose line shaping by moving some of the reference points.

For example, when moving the nasal tip (pronasale) among the reference points, the nasion and columella, which interact with the nasal tip, may move appropriately, such that the angular range of the nasal angle formed by the line connecting each type of three reference points is controlled to be maintained within the preset range.

The virtual nose shaping control module 134 may enable the overall proportion of the nose line selected by the patient during the virtual nose shaping to be maintained.

To this end, the virtual nose shaping control module 134 may learn the extent of influence and relationships between the reference points composed of the glabella, nasal dorsum, rhinion, supratip, nasal tip, columnella, alar-columella relationship (ACR), subnasale, and pogonion and the reference angles composed of the glabella (g), nasion (n), pronasale (prn), columella (cm), subnasale (sn), labium superius (Is), and pogonion (pg) and may control the reference angles to be maintained by moving other reference points related to the moving reference points when moving specific reference points according to the learned algorithm.

In addition, the virtual nose shaping control module 134 may adjust the shape and aesthetic balance of the nose by controlling the movement of the reference point in accordance with the considerations corresponding to each reference point when the virtual nose shaping applies the nose line selected by moving the reference point displayed on the patient's side face.

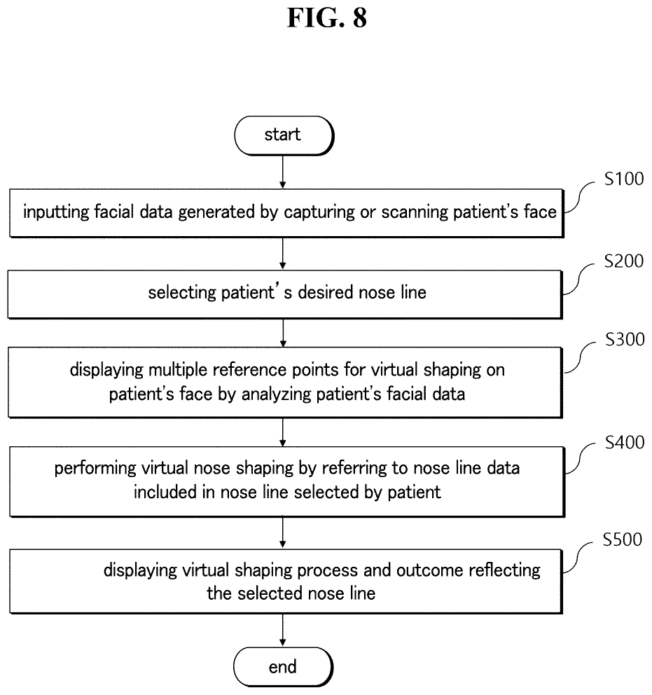

FIG. 8 is a view illustrating a virtual nose line shaping method according to an exemplary embodiment of the present disclosure.

Step S100 may be a step in which facial data generated by capturing or scanning a patient's face is input to the virtual nose shaping device 100.

The patient's facial data may be generated by capturing or scanning the patient's face by the mobile device 10, and the nose line shaping device 100 may receive the facial data from the mobile device 10.

Step S200 may be a step in which the patient selects a desired nose line.

The input facial data of the patient may be analyzed through a software for the virtual nose line shaping, and the analyzed facial data may be displayed as a side face on the display unit for the virtual nose line shaping.

Thereafter, the patient may select a desired nose line, and the selected nose line may be displayed on the display unit.

Step S300 may be a step in which the patient's facial data is analyzed and a plurality of reference points for the virtual shaping are displayed on the patient's face.

The virtual nose line shaping process of the present disclosure may be performed by moving the reference points displayed on the patient's face in accordance with the selected nose line, so the plurality of reference points for such a virtual nose line shaping may be displayed on the patient's side face.

Herein, the reference point may include the aforementioned glabella, rhinion, supratip, nasal tip, columnella, subnasale, pogonion, nasal dorsum, and alar-columella relationship (ACR), and additional auxiliary reference points may be set between each reference point for more detailed nose line shaping.

Step S400 may be a step in which the virtual nose shaping is performed by referring to the nose line data included in the nose line selected by the patient.

A person performing the virtual nose line shaping (for example, a doctor) may perform the virtual shaping of the patient's nose with the nose line selected by the patient by moving the reference points displayed on the display unit 140.

As the reference point moves, the shape of the nose related to the reference point may also move, such that the patient's nose is modified to the selected nose line (i.e., the virtual nose line shaping).

Herein, the reference point displayed on the display unit 140 may be moved by touching and dragging on a touchscreen, or may be moved using a mouse or a touch pen.

In addition, when the doctor moves a specific reference point, adjacent reference points involved in forming the nose line may automatically move as well, such that the selected nose line is formed in a natural manner.

Step S500 may be a step in which the virtual shaping process and outcome reflecting the selected nose line are displayed.

The process of performing the virtual nose line shaping may be displayed in real time on the display unit 140, and the virtual nose line outcome may also be displayed in comparison with the nose shape before the virtual nose line shaping.

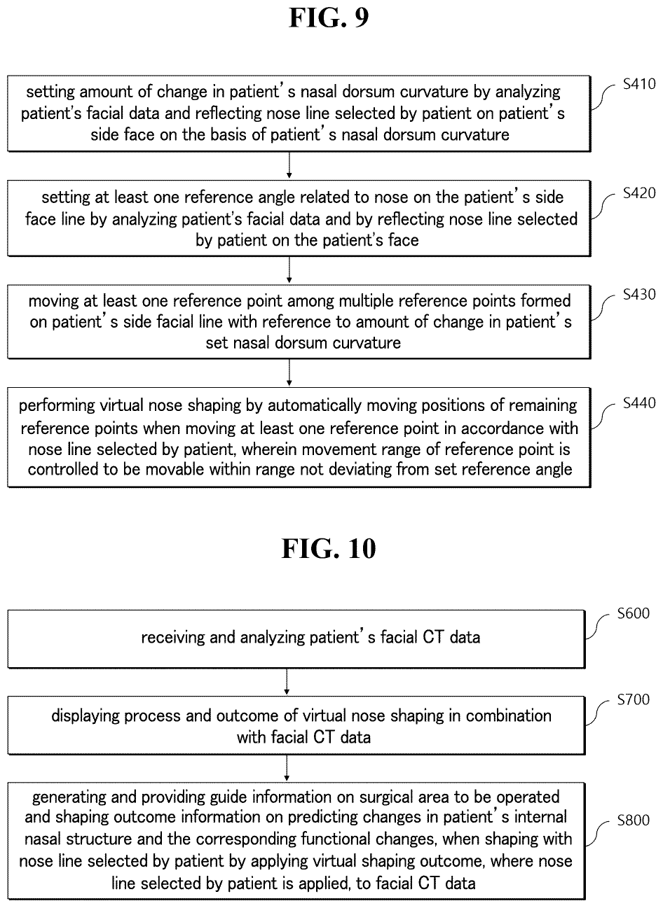

FIG. 9 is a view illustrating a nose line shaping control method of a virtual nose shaping unit according to an exemplary embodiment of the present disclosure.

The virtual nose shaping unit 130 of the present disclosure may perform a more detailed control method for the virtual nose line shaping.

Step S410 may be a step in which the amount of change in the patient's nasal dorsum curvature is set by analyzing the patient's facial data and reflecting the nose line selected by the patient on the patient's side face on the basis of the patient's nasal dorsum curvature.

The nasal dorsum curvature change setting module 131 may analyze the current nose line of the patient to analyze the nasal dorsum curvature, and then calculate the patient's nasal dorsum curvature to be changed for shaping the nose with the selected nose line, thereby setting the amount of change in the patient's nasal dorsum curvature.

Step S420 may be a step in which the patient's facial data is analyzed and at least one reference angle related to the nose on the patient's side face is set by reflecting the nose line selected by the patient on the patient's face.

The reference angle setting module 133 may analyze the patient's side face and determine the patient's current nasofrontal angle, nasal angle, nasolabial angle, facial convexity, and total facial convexity, on the basis of which, in consideration of the change in each angle of the nasofrontal angle, nasal angle, nasolabial angle, facial convexity, and total facial convexity for a natural facial contour after shaping to the selected nose line, each angle of the nasofrontal angle, nasal angle, nasolabial angle, facial convexity, and total facial convexity after the shaping may be set as the reference angle.

Step S430 may be a step in which at least one reference point among the plurality of reference points formed on the patient's side facial line is moved with reference to the amount of change in the patient's set nasal dorsum curvature.

The amount of change in the patient's set nasal dorsum curvature may be displayed on the display unit 140, and the doctor can move the nose line with reference to the amount of change in the patient's set nasal dorsum curvature and perform the virtual shaping with the selected nose line.

Herein, the amount of change in the patient's set nasal dorsum curvature and the reference points to be moved for generating the selected nose line may be selected and displayed on the display unit 140 as a guide for the virtual shaping, and the doctor may move the displayed reference points according to the amount of change in the patient's set nasal dorsum curvature and may shape the virtual nose line.

Step S440 may be a step in which, when moving at least one reference point in accordance with the nose line selected by the patient, the positions of the remaining reference points are automatically moved to perform the virtual nose shaping, but the movement range of the reference points is controlled to be movable within a range not deviating from the set reference angle.

Herein, when some reference points move, the virtual nose shaping control module 134 may control the remaining reference points related to the moving reference points to move so that a natural nose line can be formed.

In addition, the virtual nose shaping control module 134 may control the movement range of the reference point with reference to the set reference angle. That is, when the doctor moves the reference point excessively to form the selected nose line, the natural balance of the overall face may be disrupted, such that the movement range of the reference point should be restricted in order not to deviate from the range of the reference angle set for the natural balance of the face.

The virtual nose shaping control module 134 may visualize and display each amount of change when the reference point and the reference angle are changed during the virtual shaping. In particular, the extent of the visualization may be displayed in proportion to the amount of change.

For example, when displaying the nose line changed and generated as the reference point moves, the generated nose line may be displayed the same as the skin color when the extent to which the moving reference point moves within the range of the reference angle is small, and the generated nose line may be displayed in red, when the extent to which the reference point moves closer to the limit range of the reference angle is large.

In another exemplary embodiment, the nose line formed according to the movement of the reference point may be displayed in green when the extent of moving within the range of the reference angle is small, and the nose line formed according to the movement may be displayed in red, when the extent to which the reference point moves closer to the limit range of the reference angle is large.

FIG. 10 is a view illustrating a method of generating and providing guide information for plastic surgery by referring to a patient's facial CT data according to an exemplary embodiment of the present disclosure.

Step S600 is a step in which the patient's facial CT data is input and analyzed.

The virtual nose line shaping device 100 of the present disclosure may additionally receive and analyze the patient's facial CT data, such that the patient's internal nasal structure and the characteristics of the nose function according to the corresponding structure can be analyzed.

Step S700 may be a step in which the process and outcome of the virtual nose shaping are displayed in combination with the facial CT data.

In the present disclosure, the outcome of the virtual nose line shaping may be overlaid with the face before the virtual shaping, such that the changes in angle, proportion, length, and the like can be visually and numerically compared and confirmed and, if necessary, the changes before and after the shaping can be displayed more anatomically accurate by combining the virtual shaping outcome with the patient's facial CT data.

Step S800 may be a step of generating and providing the guide information on the surgical area to be operated and the shaping outcome information on predicting changes in the patient's internal nasal structure and the corresponding functional changes, when shaping with the nose line selected by the patient by applying the virtual shaping outcome, where the nose line selected by the patient is applied, to the facial CT data.

The present disclosure may visualize and display the extent of actual change in the patient's nose structure and the change in the internal nasal structure, and may generate and provide the surgical guide information for the actual nasal surgery when applying the outcome of the virtual nose line shaping to the actual nose shaping by additionally referring to the patient's CT facial data.

In addition, it is possible to predict the changes in the internal nasal structure after the shaping, and to predict and inform the extent of functional changes in the nose according to the changes in the internal nasal structure.

The present disclosure, which has the above-described structure and function, may perform the virtual nose line shaping by providing clear criteria, such as the amount of change in the nasal dorsum curvature, which is not provided by the currently used virtual shaping software, and may have the advantage of easily establishing a basic framework for the virtual shaping by setting the reference point for the virtual nose line and applying the same to the patient's facial data.

In addition, the present disclosure may have the advantage of offering a virtual shaping environment closer to reality by setting the reference point according to the patient's side facial contour required for delicate nose line shaping and the ideal reference angle range (modifiable as necessary) of the nasofrontal angle, nasal angle, nasolabial angle, facial convexity, and total facial convexity, which should be considered during the nasal surgery, and by functionally restricting any modifications deviating from those.

With these advantages, the present disclosure may provide practical assistance to both patients and doctors in preparing for and performing rhinoplasty.

The present disclosure may not be limited to the specific preferred exemplary embodiments described above, and it is obvious that those skilled in the art to which the present disclosure belongs can make various modifications without departing from the gist of the present disclosure claimed in the claims and that such modifications fall within the scope of the claims.

What is claimed is:

1. A virtual nose line shaping device, the device comprising:
a face data input unit for inputting facial data generated by capturing or scanning a patient's face;
a nose line DB for storing nose line data for at least one nose line;
a virtual nose shaping unit for displaying the nose line selected by the patient, generating a plurality of reference points for virtual nose shaping by analyzing the patient's facial data, and performing the virtual nose shaping with reference to the nose line data included in the nose line selected by the patient when moving the reference point in accordance with the nose line selected by the patient; and
a display unit for displaying a process and outcome of the virtual nose shaping.

2. The device of claim 1, wherein the facial data is generated by using a mobile device, and the virtual nose line shaping device is the mobile device or a personal computer (PC).

3. The device of claim 1, wherein the nose line comprises a straight line, a straight but slightly turned-up line, a slightly turned-up line, and a turned-up line, and the nose line data comprises information for forming the nose line.

4. The device of claim 1, wherein the virtual nose shaping unit comprises:
a nasal dorsum curvature change setting module for measuring the patient's nasal dorsum curvature and setting an amount of change in the patient's nasal dorsum curvature by reflecting the nose line selected by the patient on the basis of the measurement;
a reference point setting module for setting the plurality of reference points along a contour of the patient's side facial line for the nose shaping;
a reference angle setting module for setting at least one reference angle related to the nose from the patient's side facial line by analyzing the facial data; and
a virtual nose shaping control module for controlling to perform the virtual nose shaping within a range not deviating from the reference angle set appropriately for the patient when performing the virtual nose shaping in which the amount of change in the nasal dorsum curvature set by using the reference points is reflected.

5. The device of claim 4, wherein the plurality of reference points comprises a glabella, nasal dorsum, rhinion, supratip, nasal tip, columnella, subnasale, and pogonion.

6. The device of claim 4, wherein the reference angle is set to each angular range for a nasofrontal angle, nasal angle, nasolabial angle, facial convexity, and total facial convexity, appropriate for the corresponding patient, on the basis of an analysis of the patient's facial data when performing the virtual nose shaping by applying the nose line selected by the patient.

7. The device of claim 4, wherein the virtual nose shaping control module performs the virtual nose shaping by automatically moving positions of remaining reference points when moving at least one reference point in accordance with the nose line selected by the patient, wherein a movement range of the reference point is controlled to be movable within a range not deviating from the set reference angle.

8. The device of claim 4, wherein when a nose length, proportion, and reference angle change according to a movement of the reference point during the virtual shaping, the amount of change is visualized and displayed and an extent of the visualization is displayed in proportion to the amount of change.

9. The device of claim 1, further comprising:
a nose shaping guide information providing unit for providing guide information in performing rhinoplasty by predicting changes in the patient's internal nasal structure and the corresponding functional changes when performing the actual rhinoplasty by receiving and analyzing the patient's facial CT data, combining and displaying the process and outcome of the virtual nose shaping with the facial CT data, and applying the nose line selected by the patient.

10. A virtual nose line shaping method, the method comprising:
a) inputting, by a face data input unit, facial data generated by capturing or scanning a patient's face;
b) displaying, by a virtual nose shaping unit, the patient's facial data and displaying the corresponding nose line when the patient selects a nose line;
c) displaying, by the virtual nose shaping unit, a plurality of reference points for virtual nose shaping on the patient's face by analyzing the patient's facial data;
d) performing, by the virtual nose shaping unit, the virtual nose shaping with reference to a nose line data included in the nose line selected by the patient when moving the reference point in accordance with the nose line selected by the patient; and
e) displaying, by a display unit, a process and outcome of the virtual shaping reflecting the nose line.

11. The method of claim 10, wherein the facial data is generated by using a mobile device.

12. The method of claim 10, wherein the nose line comprises a straight line, a straight but slightly turned-up line, a slightly turned-up line, and a turned-up line, each of which comprises the nose line data for forming the corresponding nose line.

13. The method of claim 10, wherein step d) comprises:
d-1) setting, by a nasal dorsum curvature change setting module, an amount of change in the patient's nasal dorsum curvature by reflecting the nose line selected by the patient onto the patient's side face on the basis of the patient's nasal dorsum curvature by analyzing the facial data;
d-2) setting, by a reference angle setting module, at least one reference angle related to the nose on the patient's side facial line by analyzing the facial data and reflecting the nose line selected by the patient onto the patient's face;
d-3) moving, by a virtual nose shaping control module, at least one reference point among the reference points formed on the patient's side facial line with reference to the amount of change in the patient's set nasal dorsum curvature; and
d-4) performing, by the virtual nose shaping control module, the virtual nose shaping by automatically moving positions of remaining reference points when moving at least one reference point in accordance with the nose line selected by the patient, wherein a movement range of the reference point is controlled to be movable within a range not deviating from the set reference angle.

14. The method of claim 10, wherein the plurality of reference points comprises a glabella, nasal dorsum, rhinion, supratip, nasal tip, columnella, subnasale, and pogonion.

15. The method of claim 13, wherein the reference angle is each angular range for a nasofrontal angle, nasal angle, nasolabial angle, facial convexity, and total facial convexity, appropriate for the corresponding patient, on the basis of an analysis of the facial data in order to perform the virtual shaping with the selected nose line.

16. The method of claim 13, wherein step e) further comprises:
visualizing and displaying the amount of change when the reference point and the reference angle change during the virtual shaping, wherein an extent of the visualization is displayed in proportion to the amount of change.

17. The method of claim 10, further comprising:
f) receiving and analyzing the patient's facial CT data by a nose shaping guide information providing unit;
g) combining and displaying the process and outcome of the virtual nose shaping with the facial CT data by the nose shaping guide information providing unit; and
h) generating and providing, by the nose shaping guide information providing unit, guide information on a surgical area to be operated and shaping outcome information on predicting changes in the patient's internal nasal structure and the corresponding functional changes when performing an actual rhinoplasty with the nose line selected by the patient by applying the outcome of the virtual shaping, to which the nose line selected by the patient is applied, to the facial CT data.
